(19) United States
(12) Patent Application Publication
(10) Pub. No.: US 2008/0191893 A1
(43) Pub. Date: Aug. 14, 2008

(54) Method and Apparatus For Carrying Out a Task of Sensor Netowrk

(75) Inventors: Feng Li, Shanghai (CN); Xin Chen, Shanghai (CN); Yongquin Zeng, Shanghai (CN); Ningjiang Chen, Shanghai (CN); Qinfeng Zhang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,564

(22) PCT Filed: Apr. 11, 2006
(86) PCT No.: PCT/IB06/51094

§ 371 Date: Oct. 15, 2007

(30) Foreign Application Priority Data
Apr. 20, 2005 (CN) 200510066941.6

(51) Int. Cl. G08B 21/00

(52) U.S. Cl. 340/686.6

(57) ABSTRACT

The present invention relates to a method for carrying out a task of a sensor network, comprising the steps of detecting (S101) mobile means (300) temporarily entering a range covered by a sensor network, and assigning the task (S109) to the mobile means to use the mobile means to finish the task. The present invention can save energy consumption of the sensor network and enhance its processing capability. The present invention also relates to a sensor network (400), sensor node (200) and mobile means (300) using said method.

### FIELD OF THE INVENTION

This invention generally relates to a sensor network, and particularly to a method and apparatus for carrying out the task of the sensor network.

### BACKGROUND OF THE INVENTION

The possible scenarios for application of the sensor network are very extensive, such as physiological monitoring, environmental (air, water, soil, etc.) monitoring, condition-triggered maintenance, intelligent space, military, inventory management, and other work unsuitable for human beings.

A sensor network generally comprises a set or sets of sensors (also referred to as nodes in the sensor network) connected together by wire or wireless means for jointly or separately doing specific work. Each sensor in the sensor network normally performs one or more of the following functions, such as sensing, storing, transmitting, forwarding, receiving inquiry, triggering events, and processing data.

Since the sensors in the sensor network are small, inexpensive, easy to deploy and stronger functionality, etc. the sensor network becomes more and more popular. But, with these special characteristics mentioned above, the most important challenge is resources restriction. For example, the resources restrictions on the sensor network include, among other things, energy consumption, storage, communication, and data processing. How to reduce energy consumption and improve performance of the sensor network is a key issue in the sensor network system.

A normal solution to reduce energy consumption and improve the performance of the sensor network is to optimize the algorithm used in the sensor network. For example, the US patent application (Pub. No. US 2003/0063585A1; the applicant: the US Honeywell Inc.; and the inventors: Mohamed F. Younis, et. al.) has disclosed a method for managing energy consumption of the sensor network: firstly, dividing the sensors of the sensor network into plurality of groups according to the given rules, with each group having a sensor acting as a gateway for forwarding data of each sensor within the group to a control node; then, creating a route table for all groups in on each gateway; and creating a relatively smaller rout table at each sensor node, so as to minimize energy consumption; after that, monitoring each sensor's available energy; and finally, re-creating said route table according to the variation of the available energy of each sensor.

The US patent application has reduced, to a certain extent, the energy consumption of each group of sensors. However, with respect to the small sensor nodes of low cost and power, there is limitation for optimization, and it can resolve the problem of energy consumption only to some extent.

Therefore, there is a need for a new method and apparatus for carrying out the task of the sensor network, which are capable of reducing the energy consumption and enhancing the processing capability of the sensor network.

### SUMMARY OF THE INVENTION

One object of the present invention is to provide a new method and apparatus for carrying out a task of a sensor network that are capable of reducing the energy consumption and enhancing the processing capability of the sensor network.

According to the first aspect of the invention, a method for carrying out a task of a sensor network is provided, comprising the steps of: detecting mobile means temporarily entering a range covered by the sensor network; and assigning the task to the mobile means to utilize the mobile means to finish the task.

According to the second aspect of the invention, a sensor network is provided, comprising a detecting unit for detecting mobile means temporarily entering a range covered by the sensor network; and an assigning unit for assigning the task to the mobile means to utilize the mobile means to finish the task.

According to the third aspect of the invention, a sensor node is provided, comprising a detecting unit for detecting mobile means temporarily entering a range covered by the sensor node; and an assigning unit for assigning the task to the mobile means to utilize the mobile means to finish the task.

According to the fourth aspect of the present invention, mobile means are provided, the mobile means comprise a receiving unit for receiving a task from a sensor network; and a processing unit for processing the task.

According to the present invention, when mobile means enter a range covered by a sensor network, the function of the mobile means can be dynamically used by the sensor network in such a way that the sensor network can reduces its energy consumption and expand its capability and performance.

The other objects and achievements of the present invention will be made more apparent, and the present invention will be more comprehensively understandable by the following description and claims with reference to the appended drawings.

### BRIEF DESCRIPTION OF THE DRAWINGS

Following is a detailed description of the embodiments of the present invention in conjunction with the accompanying drawings, in which:

FIG. 1 is an exemplary flow chart illustrating the method according to one embodiment of the present invention;

FIG. 2 is a block diagram illustrating the structure of the sensor node according to one embodiment of the present invention;

FIG. 3 is a block diagram illustrating the structure of the mobile means according to one embodiment of the present invention;

FIG. 4 is a schematic diagram illustrating an embodiment of the method for carrying out the task of the sensor network;

FIG. 5 is a schematic diagram illustrating another embodiment of the method for carrying out the task of the sensor network; and

FIG. 6 is a schematic diagram illustrating yet another embodiment of the method for carrying out the task of the sensor network;

In the drawings, the identical referential numbers indicate the identical or similar features and functions.

### DETAILED DESCRIPTION OF THE INVENTION

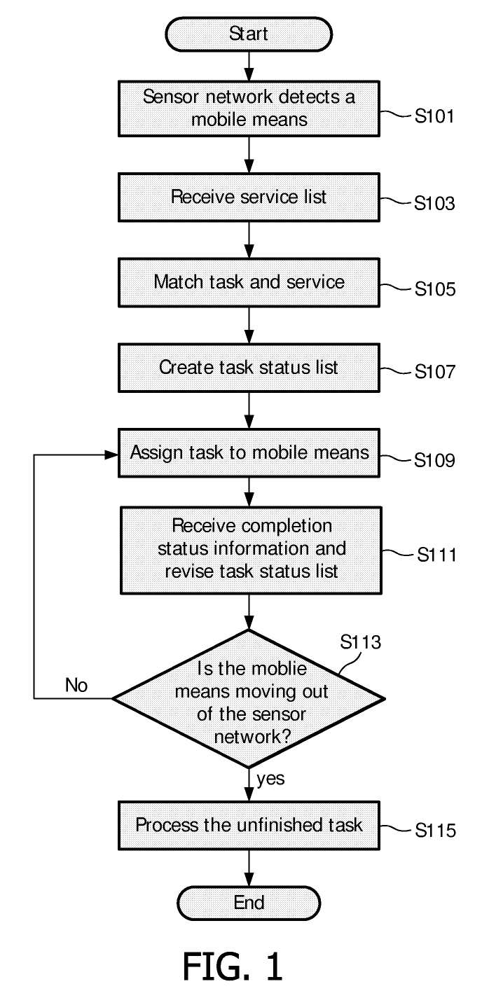

FIG. 1 is an exemplary flow chart illustrating the method for carrying out a task of a sensor network according to the present invention. In step S101, when a mobile means enters a range covered by a sensor network, the sensor network detects the mobile means. The sensor network is a user's home sensor network, which may be a wire or wireless sensor network. Furthermore, the sensor network may also be an office sensor network, or a hospital sensor network suitable for a variety of applications of detecting, monitoring and remote medical diagnosis, etc. The mobile means is a mobile phone. Of course, the mobile means may be a PDA (Personal Digital Assistant), an intelligent telephone, or a media player, etc.

The sensor network can detect the mobile means according to the short range wireless communication protocol among the mobile means. For example, when the mobile means approaches the sensor network, the sensor network detects, according to the protocols, such as the Bluetooth, Wi-Fi, Zigbee, RF, or Infrared, etc., the mobile means by capturing the wireless signal emitted from a mobile means. After that, the sensor network can determine, according to the wireless signal, that the mobile means have entered the range covered by the sensor network. Additionally, the sensor network can also use communication parameters to determine whether a mobile means can create communication channel with a network. These communication parameters are possibly those of delay, bit error rate and consumed energy, etc.

For one of the methods for detecting mobile means, see U.S. Pat. No. 6,493,550 B1 (filed on Nov. 20, 1998; licensed to the Ericsson Inc.; and invented by Raith and Alex Krister). The U.S. Pat. No. 6,493,550 B1 has disclosed an adjacent system and radio communication system. The adjacent system can notify the mobile station, when a mobile station approaches it, and the mobile station comprises an adjacent prober for identifying adjacent signals emitted by the adjacent system. Once the adjacent signals are identified, search is triggered for the special radio communication control channel. The disclosure of the U.S. Pat. No. 6,493,550 B1 is incorporated as a reference.

Since it is possible for mobile means of different users to enter the sensor network, it is necessary to determine whether it is to use the identity of the mobile means. After determination is made that the communication channel can be established between the sensor network and the mobile means, signals are then exchanged between the sensor network and the mobile means to authenticate the mobile means. For example, when a friend's mobile means temporarily enter a user's home sensor network, in one circumstance, it is to check whether the user of the mobile means has authorized any other network or device to use the mobile means. It is because the friend possibly does not want another person's sensor network to use any resources of his mobile means. In the other circumstance, the sensor network determines whether it wants to use the mobile means having entered its range. For example, the user's home sensor network possibly does not want to use any mobile means other than that of the family members. In case like this, even if the friend's mobile means has entered the range covered by the sensor network, the sensor network would not assign any task to the mobile means.

In step S103, the service list is received from the mobile means. The service list is generated by the application program running on the mobile means for describing the function and the present availability of the mobile means. For example, the mobile means is available, at the present, to provide the services, such as the Internet connection, forwarding, storage and computation and so on, the mobile means generates a service list including said services and transmits it to the sensor network, informing the sensor network of the services now available to provide.

After that, in step S105, the sensor network matches the tasks it is about to carry out and the service list it has received, and finds out the task that can be assigned to the mobile means. For example, the sensor network now has a statistic task and a data transmitting task, and the mobile means can perform the function of computation and forwarding according to the service list. Therefore, there are two tasks that can be matched.

Then, in step S107, the sensor network creates a task status list (TSL) for reflecting the information relating to the processing of the tasks assigned to the mobile means. For example, if the sensor network is ready to assign the two tasks of computation and forwarding to the mobile means for finishing, the two tasks are added to the task status list, and set the processing status as “unfinished”.

Then, in step S109, a matched task is assigned to the mobile means to enable it to help finish the task, so as to make an effective use of the mobile means and reduce energy consumption of the sensor network. For example, in assigning a computation-related task to a mobile means, a sensor network may transmit the data to the adjacent mobile means in mobility collectively. In this way, the computation tasks of statistics, analysis and processing can be executed in the mobile means, so as to save the power for the sensor network and facilitate the rapid data analysis, etc.

Additionally, a sensor network may also use the memory of mobile means to store or to back up the data relating to a user or means, in order to retrieve these data at some time in the future.

Then, in step S111, the sensor network receives information relating to the processing of the assigned task from a mobile means. The information may be a sign of the finished task, or the result of the assigned task. For example, the task assigned to the mobile means is a task to backup data, then, after backing up the data the sensor network transmitted to the mobile means, the mobile means returns a sign of task completion. If the task assigned to the mobile means is one of computation, then, the mobile means returns the result of computation to the sensor network. After receiving the information of the completion of the task, the sensor network revises the status of the corresponding task in the task status list into “finished”.

Of course, due to its mobility characteristic, it is possible that the mobile means moves out the range covered by the sensor network any time. In case like this, in step S113, the sensor network judges whether a mobile means is moving out of a sensor network. The sensor network can determine, through probing the fading of the wireless signal, that mobile means is moving out of the range covered by a sensor network. It can also use the parameters of delay, bit error rate or energy consumed to determine that mobile means are moving out of the range covered by a sensor network.

If the mobile means do not move out of the range covered by the sensor network, then go back to step S109 to proceed to assign a next task to the mobile means.

Above is a description of the case of the sensor network assigning a task to the mobile means that temporarily enters the range the sensor network covers at a time. It should be understood that the sensor network can simultaneously assign a plurality of tasks to the mobile means, or assign one to a plurality of mobile means that temporarily enters the range covered by the sensor network. Further, the sensor network may also simultaneously assign a plurality of tasks to a plurality of mobile means according to the service lists of a plurality of mobile means.

If the mobile means have moved out of the range covered by the sensor network, in steps S115, the sensor network checks the task status list, and finish itself the task indicated as “unfinished” in the list.

Above is the description of the method according to one embodiment of the present invention in conjunction with FIG. 1. Each step of the method of the present invention can be further improved.

For example, the service list in step S103 may be generated further according to the configuration information and present status information of the mobile means. The configuration information may include the mobile means's ways of connection, such as Ethernet, Infrared, and Wi-Fi, and information of communication and computation capability, etc. The present status information of the mobile means may include information relating to the present use state or power supply of the CPU/memory of the mobile means. In case of insufficient battery power of the mobile means, the mobile means could not be used. For safety sake, the right of the assigned task may be duly restricted. For example, it is, for the reason of confidentiality, to disallow any access to the memory space and other software unit of the mobile means in the process of one mobile means carrying out the assigned task.

Additionally, the service list may also be the mobile means' ID or type. The sensor network gets to know the services that the mobile means can provide from the profile stored in the server of the sensor network according to the ID or type.

In step S105, said task can be data exchange, computation, storage, or the combination thereof. Also, a task per se can be a large task or a part of an even larger task. In the case where the task per se is a large task, the task may be divided into a plurality of sub-tasks to facilitate the mobile means to finish the task as quickly as possible. If it is found that the data exchange by the mobile means consume more power than transmitting the data to the adjacent sensor node, the sensor network will choose to use the sensor network to finish the task, rather than assign the task to the mobile means.

In step S113, if mobile means are moving out of the range covered by a sensor network and the task that is now assigned to the mobile means are yet to be finished, then, the sensor network sends a warning signal to the mobile means. After it receives the warning signal, the mobile means prompt a window, or emits a warning sound to remind the user of the mobile means that the mobile means are carrying out the task assigned to it by the sensor network. If the user stops moving out upon seeing the warning signal, then the mobile means can go on finishing the assigned task, Conversely, if the user continues to move out of the range covered by the sensor network, then the task assigned by the sensor network is unfinished. Then, in step S115, the unfinished task is processed by the sensor network.

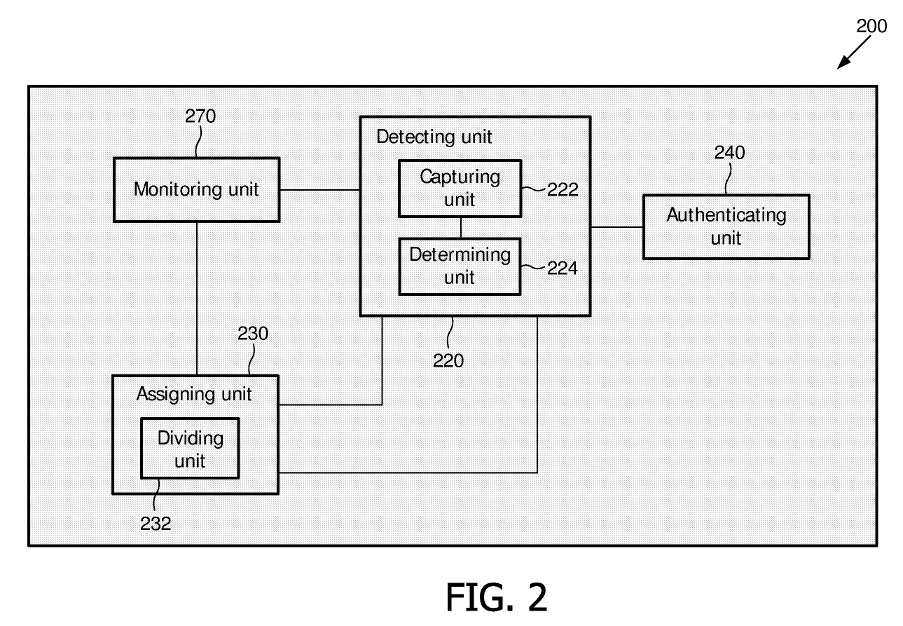

FIG. 2 is a block schematic diagram illustrating the structure of the sensor node according to one embodiment of the present invention. The sensor node is a part of a sensor network.

Sensor node 200 comprises a detecting unit 220 for detecting the mobile means temporarily entering the range covered by the sensor network, and establishing a communication channel with the mobile means. Detecting unit 200 may be a short-range wireless communication transceiver.

The sensor node 200 also comprises an assigning unit 230 for assigning a task to the mobile means, after detecting unit 220 detects the mobile means entering the range covered by the sensor network, to use the mobile means to finish the task assigned by the sensor network.

Furthermore, the sensor node 200 may also comprise an authenticating unit 240 and a monitoring unit 270. The detecting unit may further comprise a capturing unit 222 and a determining unit 224. Assigning unit may further comprise a dividing unit 232.

Capturing unit 222 of detecting unit 220 captures signals transmitted by the mobile means periodically or at variable intervals. For example, capturing unit 222 captures signals transmitted by the mobile means every 10 seconds to 1 minute to check whether the mobile means has entered the range covered by the sensor network.

Said time interval may be selected with account taken of a variety of factors, including checking, as much as possible, the mobile means, and consuming, as less as possible, the energy of the sensor network to reach a desired compromise, which depends on specific circumstances. If a sensor node has relatively stronger energy, a signal is captured at a shorter interval, say, 10 seconds. If the energy of the sensor node drops, the interval is selected to be longer, say, 30-60 seconds.

Determining unit 224 of detecting unit 220 is used for determining, according to the wireless signal captured, that the mobile means has entered the range covered by the sensor network.

Authenticating unit 240 of sensor node 200 is used for authenticating mobile means to decide whether to assign any task to the mobile means to carry it out. The Authentication of the mobile means cab be to check whether the user of the mobile means has authorized any other network or device to use the mobile means, or it is the sensor node to determine whether it wants to use the mobile means. The rules for authenticating mobile means may be the user's identity, security of the mobile means per se, or data confidentiality requirement, etc.

After authenticating unit 240 determines that the mobile means entering the sensor node can be assigned a task, capturing unit 222 receives a service list from the mobile means. Assigning unit 230 matches the service list received with the task to be carried out by the sensor network, and finds the task that can be assigned to the mobile means.

Dividing unit 232 of assigning unit 230 can divide a larger task into a plurality of smaller sub-tasks. Then, assigning unit 230 assigns at least one of the smaller sub-tasks to the mobile means.

Monitoring unit 270 creates a processing status list for the task to be assigned to the mobile means and set the status of all the tasks as “unfinished”.

After assigning unit 230 assigns a task to the mobile means, monitoring unit 270 monitors the information relating to the processing of the assigned task from the mobile means. Upon receiving information that the task is finished, monitoring unit 270 revises the status corresponding to the tasks in the task status list into “finished”. Then, assigning unit 230 proceeds to assign a next task to the mobile means.

After detecting unit 220 detects that the mobile means moves out of the range covered by the sensor network, assigning unit 230 checks the processing status list. If there is any task left unfinished, it is for the sensor network itself to finish the task.

It is understood that sensor node 200 also comprises a sensing unit (not shown in the Fig.) for performing the probing function of the sensor. For example, it may be a temperature sensor, a humidity sensor, or an optical sense.

Although in FIG. 2, it has been separately illustrated that a sensor node 200 has been integrated with detecting unit 220 (comprising capturing unit 222 and detecting unit 224), assigning unit 230 (comprising detecting unit 223), authenticating unit 240, and monitoring unit 270. It should be understood that these units and some of their sub-units can be configured in a sensor node 200, while some other units and their sub-units may be configured in another sensor node of the sensor network. For example, a sensor node has a detecting unit 220. When the node detects that a mobile means has entered the range covered by the sensor network, it notifies another sensor node having an assigning unit 230 to assign a task to the mobile means and another node having a monitoring unit 270 to monitor the processing of the task, only if the sensor network can operate cooperatively.

Likewise, sub-unit and main unit each may also belong to the different sensor nodes of a sensor network. For example, detecting unit 232 belongs to one sensor node, while assigning unit 230 to another, as long as the two sensor nodes communicate with each other.

Additionally, some or all of the units may also be implemented with software.

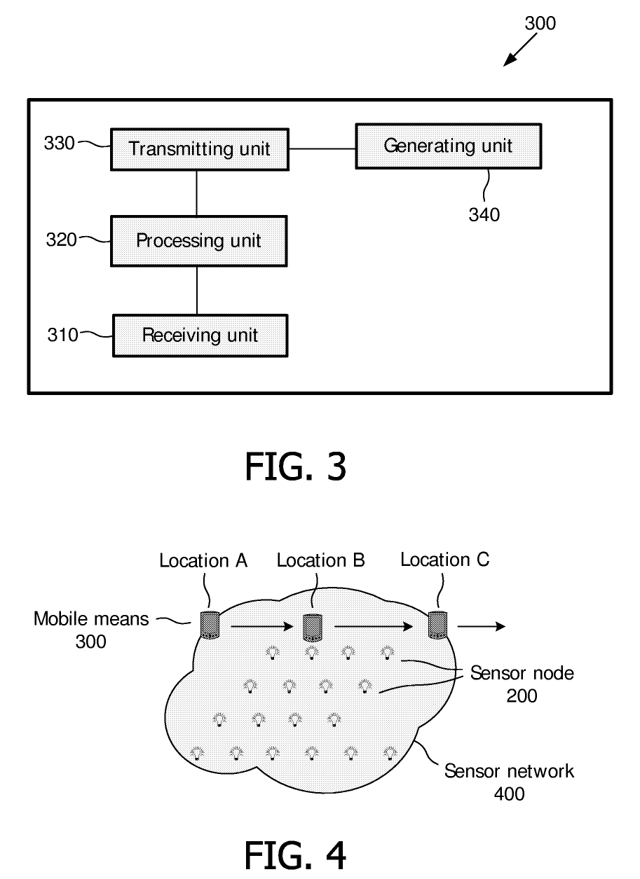

FIG. 3 is a block diagram illustrating the structure of the mobile means according to one embodiment of the present invention. Mobile means 300 comprises a receiving unit 310, and processing unit 320. Receiving unit 310 communicates with the sensor network through the short-range wireless communication protocol to receive tasks transmitted from the sensor network. Processing unit 320 is used for finishing tasks received. The mobile means is a mobile phone. Of course, the mobile means may be a PDA(Personal Digital Assistant), intelligent phone, or media player, etc.

Mobile means 300 can display, on its own display unit (not shown), the present status information to enable the user of the mobile means 300 to know about the present status of the mobile means 300, and to determine, accordingly, whether to allow the mobile means 300 to be used by a sensor network or sensor node 200.

The mobile means may also comprise a transmitting unit 330 and a generating unit 340.

Transmitting unit 330 is used for transmitting the result of task and task completion sign back to the sensor network. After mobile means 300 completes a task assigned by the sensor network, it awaits for a next task.

Generating unit 340 is used for generating a service list according to the mobile means' configuration information and its present status information to indicate the mobile means's functions and information of its present availability. Mobile means 300 transmits, through transmitting unit 330, the service list to the sensor network to enable it to assign, according the list, the suitable task to the mobile means 300.

It should be understood that said receiving unit 310 and transmitting unit 330 in combination are a short range wireless communication transceiver. Furthermore, the mobile means may work at another section of frequency spectrum (e.g. GSM, CDMA, and 3G).

Following is an exemplary description of the use of the sensor network of the present invention.

FIG. 4 is a schematic diagram illustrating an embodiment of the method for carrying out the tasks of the sensor network. A sensor network 400 consists of a plurality of sensor nodes 200. When mobile means 300 moves to location A, sensor network 400 detects that it has entered its range, and obtains the mobile means's service list. During mobile means 300 is within the range covered by the sensor network 400, that is, at location B, sensor network 400 selects a suitable task according to the obtained service list to be assigned to the mobile means to carry it out. When mobile means 300 moves to location C, and when sensor network 300 detects that mobile means 300 moves out its range, the mobile means is logged off, and the unfinished task is left to be finished by the sensor network itself.

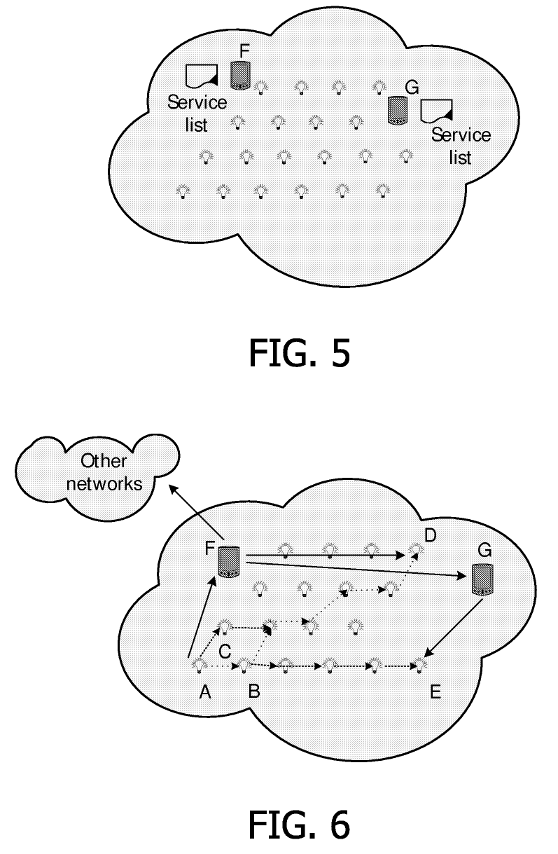

FIG. 5 is a schematic diagram illustrating another embodiment of the method for carrying out the tasks of the sensor network. When a plurality of mobile means F and G temporarily enter the range covered by the sensor network, the sensor network can obtain a plurality of mobile means's service lists and assign different tasks to a plurality of mobile means according to the service lists.

FIG. 6 is a schematic diagram illustrating yet another embodiment of the method for carrying out the tasks of the sensor network. If a sensor node A wants to transmit data to a sensor node D, but mobile means F and G are now entering the range of its coverage and can provide the data forwarding service, then the sensor node A does not transmit the data through the route where the plurality of nodes, such as sensor node C etc. are located, but directly transmit the data to mobile means F, so as to use the relative stronger communication capability of the mobile means F to directly transmit the data to target node D.

Under another circumstance, if the sensor node A is not, but node C, is in the range covered by mobile means F, then it is for node A first transmits data to node C, and then transmits the data to node D through mobile means F.

Further, if mobile means F finds another mobile means G available to the sensor network, mobile means F can also forwards data through mobile means G. For example, if a sensor node A wants to transmit data to a sensor node E, then sensor node A may not transmit the data along the route where node B is located. Instead, it transmits the data directly to mobile means F which forwards the data to mobile means G. Finally, the data is exchanged to sensor node E through mobile means G.

Further, mobile means F can also forward data of sensor network to other external networks at the request of a sensor network.

Although description has been made above in combination with the embodiments of the method of the present invention for the mobile means to carry out the tasks of the sensor network, and the corresponding sensor network, sensor nodes and mobile means. It should be clear, however, that the present invention can be put to other applications, and the present invention is by no means limited only to what have been specifically discussed here.

It should be understood that those skilled in the art can also make all sorts of alternatives, modifications and variations on the basis of what has been described above. When any alternatives, modifications and variations fall within the spirit and the range of the claims of the present invention, they should be what have been covered in the present invention.

1. A method for carrying out a task of a sensor network, comprising the steps of:
a. detecting mobile means temporarily entering a range covered by the sensor network; and
b. assigning the task to the mobile means to use the mobile means to finish the task.

2. A method according to claim 1, wherein step a comprises the steps of:
capturing wireless signal emitted by said mobile means; and
determining, according to the wireless signal, that the mobile means have entered the range covered by said sensor network.

3. A method according to claim 1, wherein said task is at least one of the tasks of data exchange, computation, and storage.

4. A method according to claim 1, wherein the step b comprises the steps of:
dividing said task into a plurality of sub-tasks; and
assigning at least one of the plurality of sub-tasks to the mobile means to use the mobile means to finish at least one sub-task.

5. A method according to claim 1, further comprising the step of:
c. authenticating an identity of said mobile means.

6. Method according to claim 1, further comprising the step of:
d. receiving a service list transmitted from said mobile means, which describes the functions and current availability of said mobile means.

7. A method according to claim 6, wherein step b comprises the steps of:
matching said service list with said task; and
assigning said task to said mobile means according to the result of the matching.

8. A method according to claim 1, further comprising the step of:
e. creating a task status list reflecting information relating to the processing of said task.

9. A method according to claim 1, further comprising the step of:
f. receiving the information relating to the processing of said task from said mobile means.

10. A method according to claim 9, further comprising the step of:
g. when said mobile means is found to move out of the range covered by said sensor network and said task is not finished, said sensor network finishes the task.

11. A sensor network, comprising:
a detecting unit for detecting mobile means temporarily entering a range covered by the sensor network; and
an assigning unit for assigning the task to the mobile means to use the mobile means to finish the task.

12. Sensor network according to claim 11, wherein said detecting unit comprises:
a capturing unit for capturing wireless signal emitted by said mobile means; and
a determining unit for determining, according to the wireless signal, that the mobile means have entered the range covered by said sensor network.

13. A sensor network according to claim 12, wherein:
said capturing unit is also used for receiving a service list transmitted from said mobile means, which describes the functions and current availability of said mobile means.

14. A sensor network according to claim 11, wherein said assigning unit comprises:
a dividing unit for dividing said task into a plurality of sub-tasks.

15. A sensor network according to claim 11, further comprising:
an authenticating unit for authenticating an identity of said mobile means.

16. A sensor network according to claim 11, also comprising:
a monitoring unit for creating a task status list reflecting the information relating to the processing of said task.

17. A sensor node, comprising:
a detecting unit for detecting mobile means temporarily entering a range covered by a sensor network; and
an assigning unit for assigning the task to the mobile means to use the mobile means to finish the task.

18. A sensor node according to claim 17, wherein said detecting unit comprising:
a capturing unit for capturing wireless signal emitted by said mobile means; and
a determining unit for determining, according to the wireless signal, that the mobile means has entered the range covered by said sensor network.

19. A sensor node according to claim 18, wherein
said capturing unit is also used for receiving a service list transmitted from said mobile means, which describes the functions and current availability of said mobile means.

20. A sensor node according to claim 17, wherein said assigning unit comprising:
a dividing unit for dividing said task into a plurality of sub-tasks.

21. A sensor node according to claim 17, further comprising:
an authenticating unit for authenticating an identity of said mobile means.

22. A sensor node according to claim 17, further comprising:
a monitoring unit for creating a task status list reflecting the information relating to the processing of said task.

23. A mobile apparatus, comprising:
a receiving unit for receiving a task from a sensor network; and
a processing unit for processing the task.

24. A mobile apparatus according to claim 23, also comprising:
a transmitting unit for transmitting information relating to the processing of said task to the sensor network.

25. A mobile apparatus according to claim 23, further comprising:
a generating unit for generating a service list describing the functions and current availability of said mobile means.
